(19) United States
(12) Patent Application Publication
(10) Pub. No.: US 2008/0266492 A1
(43) Pub. Date: Oct. 30, 2008

(54) LIGHT EMITTING OPTICAL FILM AND MANUFACTURE METHOD THEREOF AND LIQUID CRYSTAL DISPLAY DEVICE

(75) Inventors: Yue-Shih Jeng, Miaoli County (TW); Kei-Hsiung Yang, Taoyuan County (TW)

Correspondence Address: J C PATENTS, INC., 4 VENTURE, SUITE 250, IRVINE, CA, 92618, US

(73) Assignees: TAIWAN TFT LCD ASSOCIATION, Hsinchu (TW); CHUNGHWA PICTURE TUBES, LTD., Taipei (TW); AU OPTRONICS CORPORATION, Hsinchu (TW); HANNSTAR DISPLAY CORPORATION, Tao-Yuan Hsien (TW); CHI MEI OPTOELECTRONICS CORPORATION, Tainan County (TW); INDUSTRIAL TECHNOLOGY RESEARCH INSTITUTE, Hsinchu (TW); TPO DISPLAYS CORP., Miao-Li County (TW)

(21) Appl. No.: 11/849,710

(22) Filed: Sep. 4, 2007

(30) Foreign Application Priority Data
Apr. 30, 2007 (TW) 96115251

(51) Int. Cl. G02F 1/13357; G02F 1/13

(52) U.S. Cl. 349/71; 445/58

(57) ABSTRACT

A light emitting optical film at least including a substrate, an alignment layer and a polarized light emitting liquid crystal film is provided, in which the polarized light emitting liquid crystal film includes liquid crystal and light-emitting dye. The alignment layer is located on one side of the substrate, and the polarized light emitting liquid crystal film is located on the alignment layer. The light emitting optical film can be applied to polarizing film, phase retardation film or color filter. Moreover, it is unnecessary to use conventional backlight module because overall arrangement of liquid crystal can fully emit uniform polarized light, whereby greatly reducing cost of conventional backlight module.

### CROSS-REFERENCE TO RELATED APPLICATION

This application claims the priority benefit of Taiwan application serial no. 96115251, filed on Apr. 30, 2007. All disclosure of the Taiwan application is incorporated herein by reference.

### BACKGROUND OF THE INVENTION

1. Field of the Invention

The present invention relates to a light emitting optical film, a manufacture method thereof, and a liquid crystal display (LCD) device.

2. Description of Related Art

As for the manufacturing process and design of a conventional optical film used by a display device, the manufacturing process is complex and the cost is high. Furthermore, a substrate layer is required for support or protection, so as to finish the manufacturing process and the design of the optical film. The optical film is mainly used through adhering. The manufacturing process not only restricts the materials and functions, but also redundant substrate causes the over-high material cost, directly or indirectly affects the optical characteristics, and further results in a problem that the optical film has a high thickness.

Furthermore, a liquid crystal panel is not a self-emission display panel, so the current LCD device requires a backlight module to provide a backlight source. Additionally, since the light utilization efficiency is relatively low, if it intends to achieve the characteristics of high definition, high brightness, low power consumption, or high accuracy, a variety of optical films must be used to improve or enhance the optical characteristics, for example, polarizing film, wide view film, diffusion film, prism film (also called brightness enhancement film) etc. Therefore, the researching about how to replace even omit the optical films has become one of the key issues for reducing the cost considered by persons in various fields.

### SUMMARY OF THE INVENTION

Accordingly, the present invention is directed to a light emitting optical film, capable of replacing the polarizing film, the phase retardation film, the color filter, or common optical films currently used in the display device.

The present invention is also directed to a method for manufacturing a light emitting optical film, capable of coating the light emitting optical film in a large area.

The present invention is further directed to an LCD device without the conventional backlight module, which is capable of greatly reducing the cost spent on the conventional backlight module.

As embodied and broadly described herein, the present invention provides a light emitting optical film, which includes a substrate, an alignment layer, and a polarized light emitting liquid crystal film. The polarized light emitting liquid crystal film includes liquid crystal and light-emitting dye. The alignment layer is located on one side of the substrate, and the polarized light emitting liquid crystal film is located on the alignment layer.

The present invention further provides a method for manufacturing the light emitting optical film, which includes: firstly providing a substrate having an alignment layer located on one side; next, a polarized light emitting liquid crystal film is formed on the alignment layer by means of coating, in which the polarized light emitting liquid crystal film is at least formed by liquid crystal and light-emitting dye.

The present invention further provides an LCD device, which includes a liquid crystal panel and a light emitting source. The liquid crystal panel at least includes a means constituted by a second alignment layer and a polarized light emitting liquid crystal film, and the polarized light emitting liquid crystal film includes liquid crystal and light-emitting dye. The light emitting source is located on any side of the liquid crystal panel, and lights emitted by the light emitting source can enable the polarized light emitting liquid crystal film to emit lights at wavelength scope different from that of the lights emitted by the light emitting source.

In the present invention, the liquid crystal material alignment function is utilized together with the light-emitting dye to perform the coating process, so as to form the polarized light emitting liquid crystal film, which achieves the optical functions of polarization or phase difference compensation, and further enhances the light emitting function. Therefore, under the circumstance that the coating process is used together, not only the difficulty for manufacturing of the display device in a large area is overcome, but the color filter currently used in the display device is also replaced. As for the light emitting optical film, it is unnecessary to use conventional backlight module because overall arrangement of liquid crystal can fully emit uniform polarized light, whereby greatly reducing cost spent on the conventional backlight module.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1C are respectively sectional views of three structural variations of a light emitting optical film according to a first embodiment of the present invention.

FIG. 2 is a flow chart for manufacturing a light emitting optical film according to a second embodiment of the present invention.

FIG. 3 is a curve diagram of the polarizing rate for the light emitting optical film manufactured through the steps of the second embodiment after absorbing light.

FIG. 4 is a curve diagram of light intensity and wavelength excited by the light emitting optical film manufactured through the steps of the second embodiment, after absorbing lights of 398 nm.

FIG. 5 is a curve diagram of the phase difference for the light emitting optical film manufactured through the steps of the second embodiment used as the light emitting phase retardation film.

FIGS. 6A to 6F are respectively sectional exploded views of six structural variations of an LCD device according to a third embodiment of the present invention.

### DESCRIPTION OF EMBODIMENTS

The present invention is fully described below with reference to the accompanying drawings, and embodiments are shown in the accompanying drawings. However, the present invention can be represented by many different configurations, and it should not be explained as being limited in the embodiments of the present invention. Practically, the embodiments are provided to demonstrate the present invention in a more detailed and complete way, and to enable those of ordinary skill in the art to completely appreciate the scope of the present invention. In the drawings, in order to be explicit, the size and the relative size of each layer and area are depicted in an exaggerated way. The same reference numbers will be used throughout the drawings to refer to the same or like parts.

In the present invention, relative space terms, for example, “under”, “above”, “between”, and the like are used for the ease of description, so as to describe the relation between one layer or feature and another layer (or other layers) or feature illustrated in the drawing. It should be understood that, the relative space terms refer to different directions of the elements in using or operating except for those directions described in the drawing. For example, if the element in the drawing is turned over, the layer (or element) originally described as being located “under” or “below” a certain layer (or element) is now positioned or located “above” the certain layer (or element). Therefore, the so-called “under” can include two directions of above and below.

### The First Embodiment

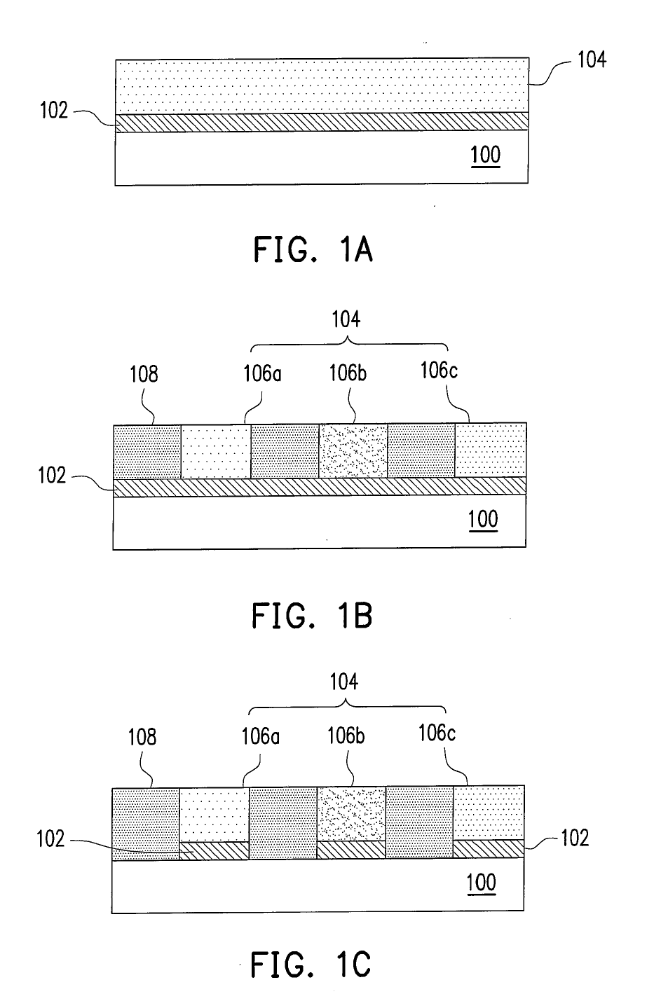

FIGS. 1A to 1C are respectively sectional views of three structural variations of a light emitting optical film according to a first embodiment of the present invention.

Firstly, referring to FIG. 1A, a first light emitting optical film includes a substrate 100, an alignment layer 102, and a polarized light emitting liquid crystal film 104. The polarized light emitting liquid crystal film 104 includes liquid crystal and light-emitting dye. The liquid crystal is, for example, liquid crystal polymer, liquid crystal oligomer, or liquid crystal monomer. The light-emitting dye is organic light-emitting diode (OLED)-like dyes, for example, dichroic dyes. The polarized light emitting liquid crystal film 104 can change the color of the light according to different wavelength characteristics of different light-emitting dyes. The substrate 100 can be a light-transmissive substrate or an opaque substrate.

Referring to FIG. 1A, the alignment layer 102 is located on any side of the substrate 100, and the polarized light emitting liquid crystal film 104 is located on the alignment layer 102. The polarized light emitting liquid crystal film 104 in the first embodiment can be applied as a polarizing film or a phase retardation film. The polarized light emitting liquid crystal film 104 having the light-emitting dye can respectively perform multiple alignments. In addition, the polarized light emitting liquid crystal film 104 can be further applied as a color filter, as shown in FIG. 1B or FIG. 1C.

In the light emitting optical film of the first embodiment, the polarized light emitting liquid crystal film 104 can also be formed by a plurality of patterns 106a, 106b, and 106c, and the excited light emitting wavelength of each pattern 106a, 106b, and 106c may be the same or different. In addition, a shielding layer 108 is further disposed between the patterns 106a, 106b, and 106c to separate them from each other, and the shielding layer 108 can be a black matrix, so as to shield the visible lights at different wavelengths to scatter in other patterns, and thus ensuring the color purity. The alignment layer 102 is located between the shielding layer 108 and the patterns 106a-c and the substrate 100 (as shown in FIG. 1B), alternatively, the alignment layer 102 is only located between each pattern 106a, 106b, and 106c and the substrate 100 (as shown in FIG. 1C).

Referring to FIGS. 1B and 1C, when the patterns 106a, 106b, and 106c represent light emitting regions with different wavelengths, the function thereof is similar to the color filter structure. Therefore, the patterns 106a, 106b, and 106c are constructed on a light emitting source, once the light emitting source emits UV lights of 398 nm, the UV lights are absorbed through the polarized light emitting liquid crystal film 104. Then, the polarized light emitting liquid crystal film 104 re-emits the polarized visible light, and the different patterns 106a-c can individually emit different polarized visible light, for example, RGB polarized lights or RGBW polarized lights, so as to replace the color filter and the polarizer of the conventional thin film transistor liquid crystal display (TFT LCD). The lights emitted from the polarized light emitting liquid crystal film 104 are uniform, so that optical film structures such as diffusion plate and prism film in the backlight module can be omitted. In addition, the polarized light emitting liquid crystal film 104 of the first embodiment can be located within or out of a display cell.

### The Second Embodiment

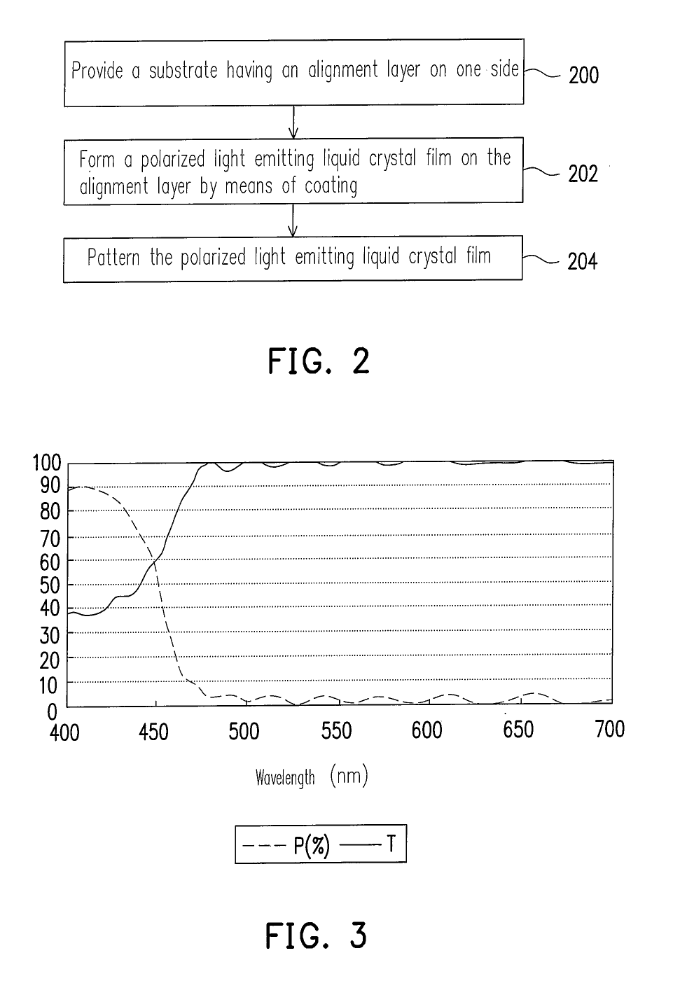

FIG. 2 is a flow chart for manufacturing a light emitting optical film according to a second embodiment of the present invention.

Referring to FIG. 2, in Step 200, a substrate is provided, which is a light-transmissive substrate or an opaque substrate. The substrate has an alignment layer on one side.

Next, in Step 102, a polarized light emitting liquid crystal film is formed on the alignment layer by means of coating, and the polarized light emitting liquid crystal film is at least formed by liquid crystal or light-emitting dye. The material of the polarized light emitting liquid crystal film is formed by dissolving the light-emitting dye in the liquid crystal, by utilizing the different light-emitting dyes absorption and the light emitting effects together with the liquid crystal combination, it is applied to optical films with different functions, such as a polarizing film capable of emitting the polarized light or a phase retardation film capable of emitting the polarized light. In addition, as for the process of forming the polarized light emitting liquid crystal film, in addition to coating the liquid crystal containing the light-emitting dye on the alignment layer, UV lights, for example, is further used to perform the curing. The thickness of the polarized light emitting liquid crystal film varies depending upon the actual application, so wherever necessary, the steps of coating and curing can be repeated till the required thickness is achieved for the polarized light emitting liquid crystal film. The coating process includes, for example, spin coating, slot-die coating, extrusion coating, inject printing, Mayer rod coating, or blade coating, etc. The coating process can also select a roll to roll process.

After Step 202, if it is necessary, Step 204 is further performed to pattern the polarized light emitting liquid crystal film into a liquid crystal film formed by a plurality of patterns, which can be used as the color filter.

In the second embodiment, the polarized light emitting liquid crystal film is manufactured within or out of a display cell.

FIGS. 3 to 5 below are curve diagrams of each optical characteristic for the light emitting optical film manufactured through the steps of the second embodiment. The tested light emitting optical film is formed by coating the liquid crystal containing the OLED-like dye on the alignment layer of the glass substrate through the spin coating or the slot-die coating, and using the UV for curing under the room temperature.

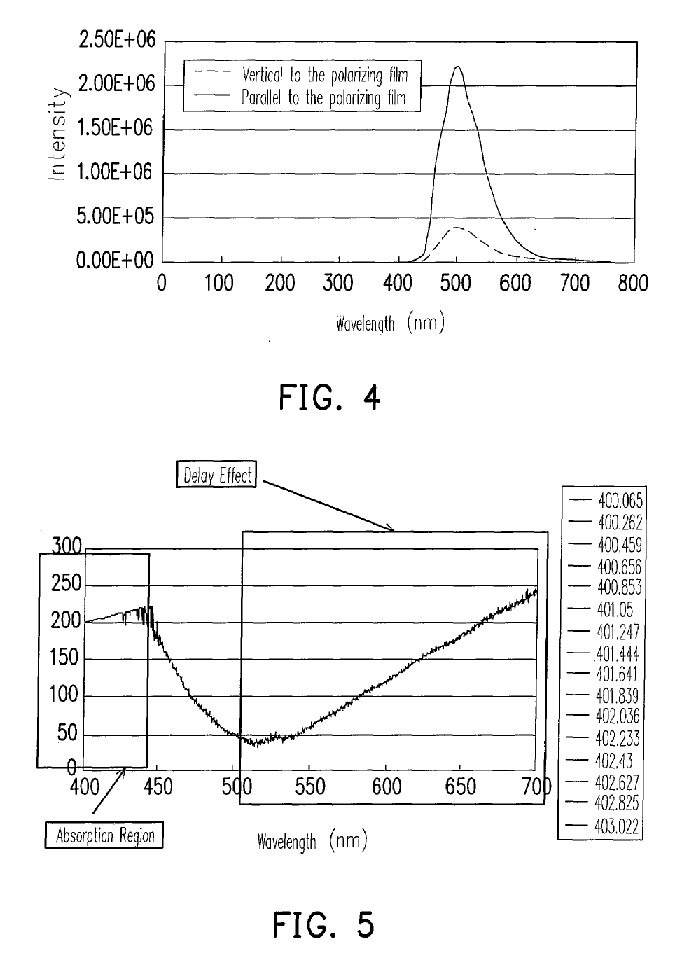

FIG. 3 shows the polarizing rate of the light emitting optical film manufactured through the steps of the second embodiment after absorbing light, in which the polarizing coefficient is approximately 90%, and the transmittance is slightly lower than 40%. FIG. 4 shows the excited light after the lights of 398 nm are absorbed, the main wavelength of the excited light is 500 nm. If it is detected by the polarizing film that the transmittance when being parallel to the polarizing film (i.e., the parallel state) is much larger than that when being vertical to the polarizing film (i.e., the cross state), it shows that the excited light has polarization characteristic. FIG. 5 shows the phase difference of the light emitting phase retardation film. It can be known from the test of using the phase difference instrument that the transmitted light has the phase difference out of the absorption wavelength of the dye, such that in the visible light region of 450 nm-700 nm, the optical film shows the phase different film characteristics. That is, the absorption wavelength and the types of the light-emitting dye are adjusted, so as to obtain the polarizing film capable of emitting the polarized light or the phase retardation film capable of emitting the polarized light.

### The Third Embodiment

The LCD device of the third embodiment mainly includes a liquid crystal panel and a light emitting source. The liquid crystal panel at least includes one means constituted by a second alignment layer and a polarized light emitting liquid crystal film, and the polarized light emitting liquid crystal film includes liquid crystal and light-emitting dye. The light emitting source is located on any side of the liquid crystal panel, and the lights emitted by the light emitting source can enable the polarized light emitting liquid crystal film to emit lights with wavelength scope different from that of the lights emitted by the light emitting source. The sectional exploded views of several structures thereof are described below.

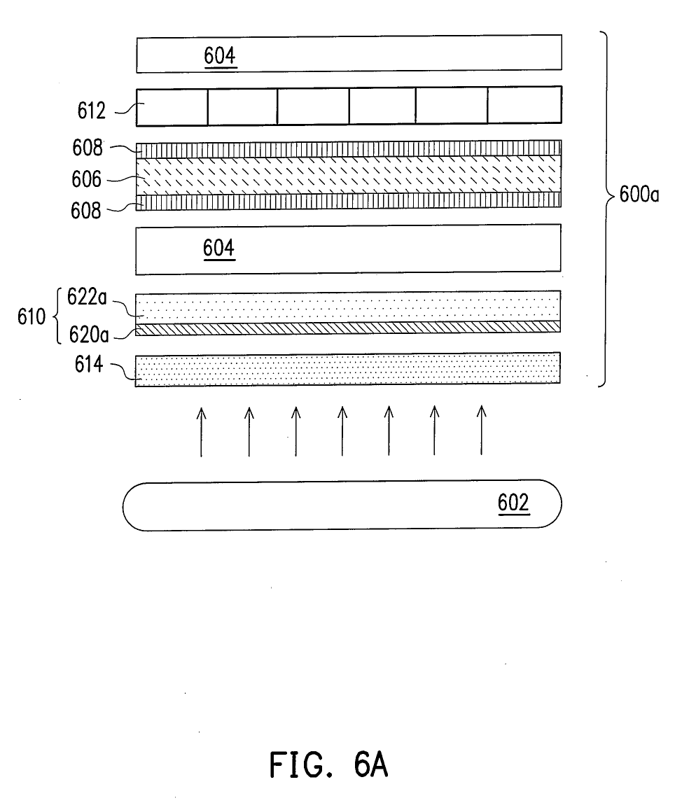

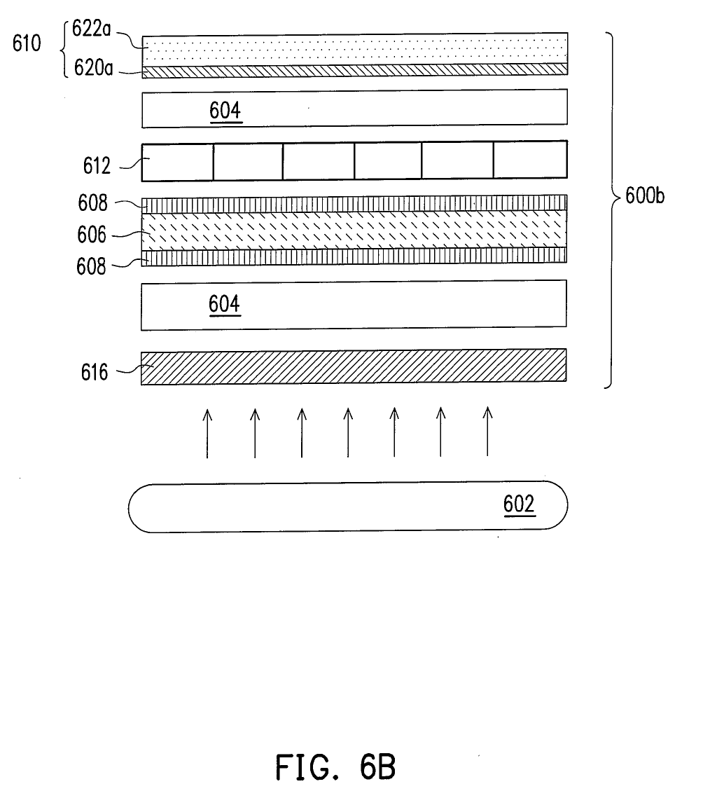

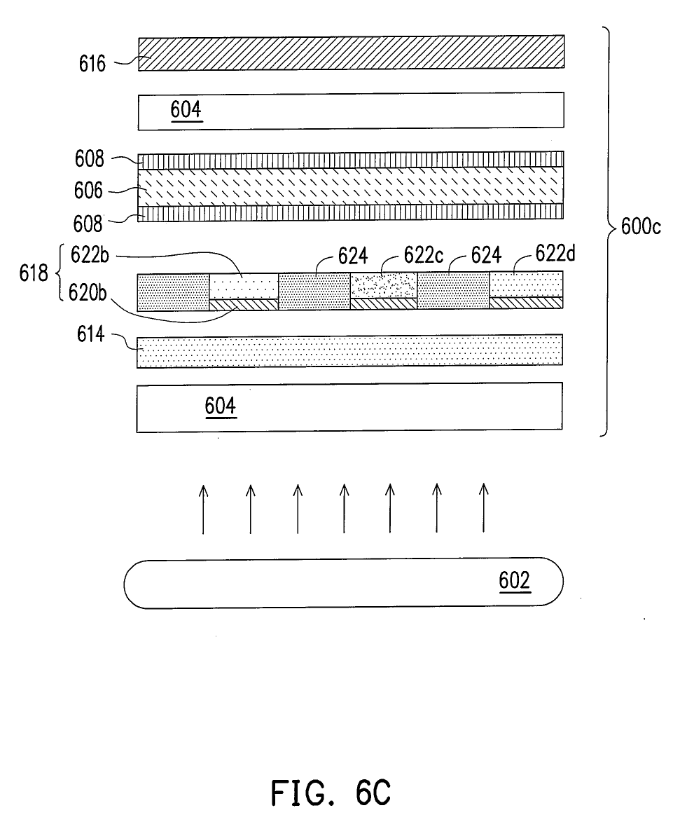

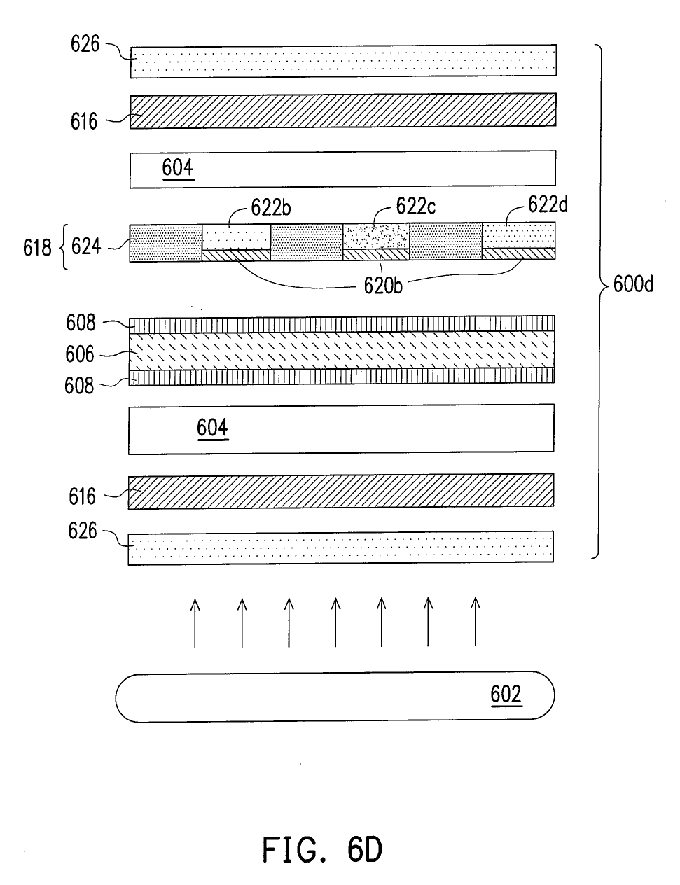

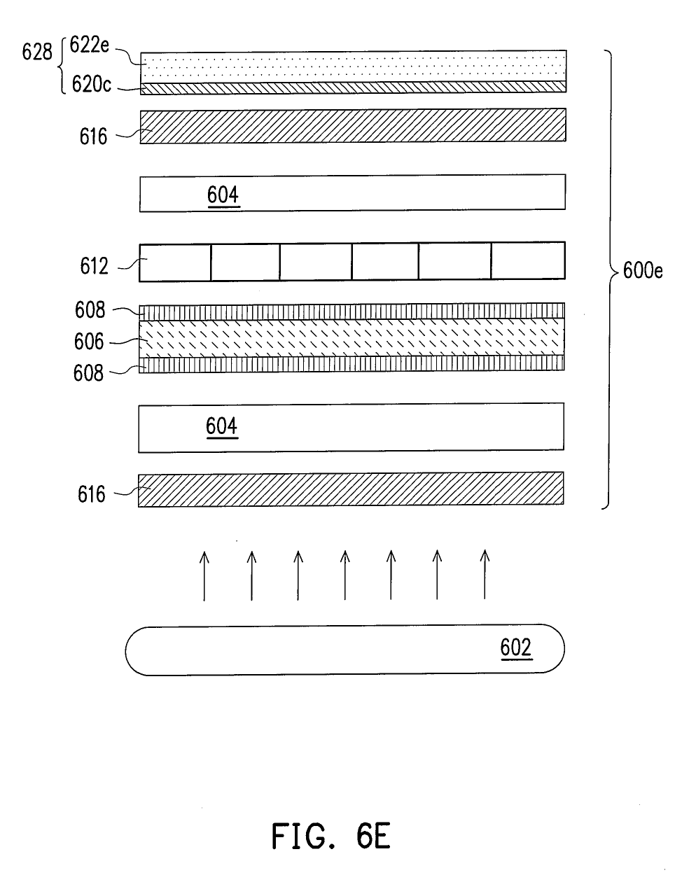

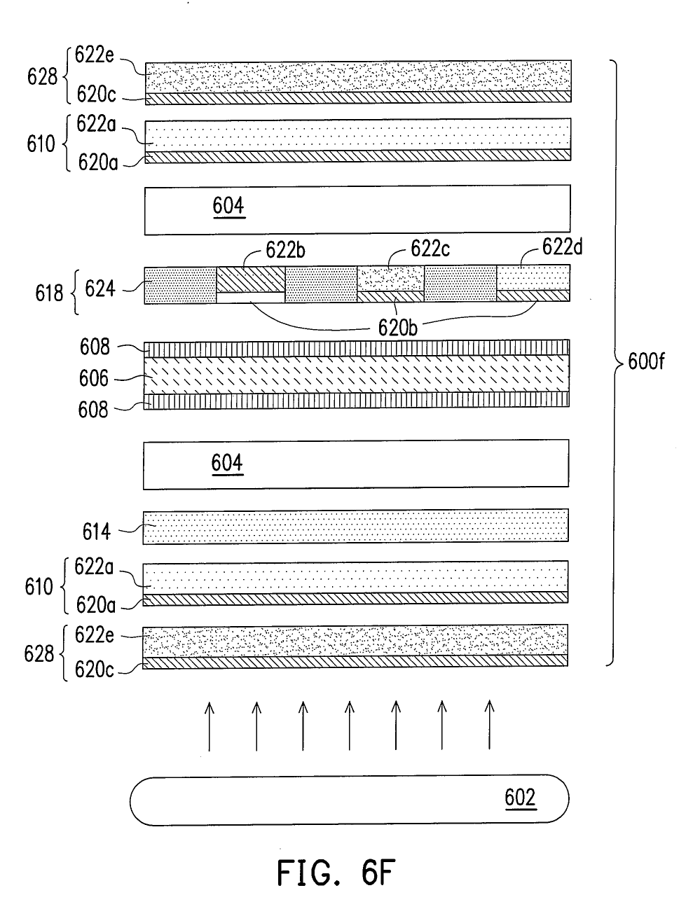

Firstly, referring to FIG. 6A, the LCD device of this embodiment includes a liquid crystal panel 600a and a light emitting source 602. The liquid crystal panel 600a includes two electrode substrates 604, a liquid crystal layer 606 sandwiched between the electrode substrates 604, and two first alignment layers 608 respectively disposed between the liquid crystal layer 606 and each electrode substrate 604. At least one polarizing film 610 is disposed on an electrode substrate 604 opposite to the liquid crystal layer 606, and a color filter 612 is disposed between the first alignment layer 608 on any side of the liquid crystal layer 606 and one of the electrode substrates 604. At least one of the polarizing film 610 and the color filter 612 is formed by a second alignment layer 620a and a polarized light emitting liquid crystal film 622a, and the polarized light emitting liquid crystal film 622a includes the liquid crystal and the light-emitting dye. The light emitting source 602 is located on any side of the liquid crystal panel 600a, and the lights emitted by the light emitting source 602 can enable the polarized light emitting liquid crystal film 622a to emit lights with wavelength scope different from that of the lights emitted by the light emitting source 602. For example, the lights emitted by the light emitting source 602 can be UV lights, and the lights emitted by the polarized light emitting liquid crystal film 622a can be visible lights. Alternatively, the lights emitted by the light emitting source 602 is a light in the scope of visible light, and the light emitted by the polarized light emitting liquid crystal film 622a is another light in the scope of visible light.

The light emitting optical film formed by the second alignment layer 620a and the polarized light emitting liquid crystal film 622a in the liquid crystal panel 600a can emit the uniform light, so the whole LCD device does not require the conventional backlight module such as backlight source, optical film structures, for example, diffusion plate, and prism film. On the contrary, the LCD of this embodiment only need one light emitting source capable of enabling the optical film to excite the light to finish the LCD device of the third embodiment. Therefore, the cost spent on the conventional backlight module is greatly reduced.

Referring to FIG. 6A, as for the LCD device in the drawing, the polarizing film 610 is replaced by the light emitting optical film formed by the second alignment layer 620a and the polarized light emitting liquid crystal film 622a. When the lights emitted by the light emitting source 602 are UV lights, and the lights emitted by the polarized light emitting liquid crystal film 622a are visible lights, a reflective layer 614 is further disposed between the light emitting source 602 and the polarized light emitting liquid crystal film 620a of FIG. 6A. The reflective layer 614 is defined as making the UV lights emitted there below to pass through and to reflect the polarized visible lights excited by the light emitting optical film, so as to reflect the polarized visible light once again for being used.

In the liquid crystal panel 600b of FIG. 6B, polarizing films 610 and 616 are disposed on two electrode substrates 604 on the opposite side of the liquid crystal layer 606, in which the polarizing film 610 includes the light emitting optical film formed by the second alignment layer 620a and the polarized light emitting liquid crystal film 622a, and the polarizing film 616 is the polarizing film known by those of ordinary skill in the art. In addition, the reflective layer is not disposed in the drawing.

In the liquid crystal panel 600c of FIG. 6C, a polarizing film 616 is disposed on an upper electrode substrate 604 on the opposite side of the liquid crystal layer 606. In addition, a color filter 618 formed by the second alignment layer 620b and the liquid crystal film constituted by the plurality of patterns 622b, 622c, and 622d is disposed between the first alignment layer 608 below the liquid crystal layer 606 and the lower electrode substrate 604. The structure of the color filter 618 is similar to the structure shown in FIG. 1C in the first embodiment, and a shielding layer 624 is disposed between the patterns 622b-d to shield the visible lights with different wavelengths to scatter in other patterns, so as to ensure the color purity. In addition, a reflective layer 614 is further disposed between the light emitting source 602 and the patterns 622b, 622c, and 622d.

The liquid crystal panel 600d of FIG. 6D further includes two phase retardation films 626 respectively disposed on each polarizing film 616 on the opposite side of the liquid crystal layer 606. The color filter 618 is disposed between the first alignment 608 on the liquid crystal layer 606 and the upper electrode substrate 604. In addition, a thin film transistor (TFT) array structure (not shown) can be disposed between the first alignment layer 608 and the lower electrode substrate 604.

Furthermore, as shown in FIG. 6E, in the liquid crystal panel 600d, the phase retardation film 628 can be replaced by the light emitting optical film formed by the second alignment layer 620c and the polarized light emitting liquid crystal film 622e. Even by means of taking a single alignment layer 620c as the original alignment function, together with the alignment function of the original functional group of the liquid crystal itself, the polarizing film containing the light-emitting dye and the phase retardation film can be integrally manufactured into an integral optical film (not shown).

If all the polarizing film 610, the phase retardation film 628, and the color filter 618 in the liquid crystal panel 600f are replaced by the light emitting optical film, the configuration is shown in FIG. 6F.

In the third embodiment, in addition to FIGS. 6A to 6F, the means and the positions can be varied, which is not limited in the drawings.

To sum up, the present invention has the following advantages.

1. In the present invention, the single alignment layer is mainly used, together with the polarized light emitting liquid crystal film including the liquid crystal and the light-emitting dye, in which the alignment function of the functional group of the liquid crystal is utilized, so as to make the polarized light emitting liquid crystal film have both the absorption and the polarized light emitting effects, thereby replacing the polarizing film, the phase retardation film, or the common optical film currently used in the display.

2. In the present invention, the full coating process is used to manufacture the polarized light emitting liquid crystal film, so as to coat the light emitting optical film in a large area.

3. When the light emitting optical film of the present invention is applied to the liquid crystal panel of the LCD device, the light emitting optical film can emit uniform lights, so the whole LCD device does not need the conventional backlight module, and thus greatly reducing the conventional cost spent on the backlight module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light emitting optical film, comprising:
a substrate;
an alignment layer, located on any side of the substrate; and
a polarized light emitting liquid crystal film, located on the alignment layer, wherein the polarized light emitting liquid crystal film comprises liquid crystal and light-emitting dye.

2. The light emitting optical film as claimed in claim 1, wherein the polarized light emitting liquid crystal film is applied as a polarizing film or a phase retardation film.

3. The light emitting optical film as claimed in claim 1, wherein the polarized light emitting liquid crystal film is applied as a color filter.

4. The light emitting optical film as claimed in claim 1, wherein the liquid crystal comprises liquid crystal polymer, liquid crystal oligomer, or liquid crystal monomer.

5. The light emitting optical film as claimed in claim 1, wherein the substrate comprises a light-transmissive substrate or an opaque substrate.

6. The light emitting optical film as claimed in claim 1, wherein the polarized light emitting liquid crystal film is located within or out of a display cell.

7. The light emitting optical film as claimed in claim 1, wherein the polarized light emitting liquid crystal film comprises a liquid crystal film formed by a plurality of patterns.

8. The light emitting optical film as claimed in claim 7, wherein excited light emitting wavelength varies for each pattern.

9. The light emitting optical film as claimed in claim 7, further comprising at least one shielding layer disposed between the patterns.

10. The light emitting optical film as claimed in claim 7, wherein each pattern individually emits RGB polarized lights or individually emits RGBW polarized lights.

11. A method for manufacturing a light emitting optical film, comprising:
providing a substrate, having an alignment layer on one side; and
forming a polarized light emitting liquid crystal film on the alignment layer by means of coating, wherein the polarized light emitting liquid crystal film is at least formed by liquid crystal and light-emitting dye.

12. The method for manufacturing the light emitting optical film as claimed in claim 11, wherein the coating process comprises spin coating, slot-die coating, extrusion coating, inject printing, Mayer rod coating, or blade coating.

13. The method for manufacturing the light emitting optical film as claimed in claim 12, wherein the coating process comprises a roll to roll process.

14. The method for manufacturing the light emitting optical film as claimed in claim 11, further comprising patterning the polarized light emitting liquid crystal film to make the polarized light emitting liquid crystal film become a liquid crystal film formed by a plurality of patterns, after the step of forming the polarized light emitting liquid crystal film on the alignment layer by means of coating.

15. The method for manufacturing the light emitting optical film as claimed in claim 11, wherein the polarized light emitting liquid crystal film is manufactured within or out of a display cell.

16. The method for manufacturing the light emitting optical film as claimed in claim 11, wherein the substrate comprises a light-transmissive substrate or an opaque substrate.

17. A liquid crystal display (LCD) device, comprising:
a liquid crystal panel, at least having a means constituted by a second alignment layer and a polarized light emitting liquid crystal film, wherein the polarized light emitting liquid crystal film comprises liquid crystal and light-emitting dye; and
a light emitting source, located on any side of the liquid crystal panel, wherein lights emitted by the light emitting source enable the polarized light emitting liquid crystal film to emit lights with wavelength scope different from that of the lights emitted by the light emitting source.

18. The LCD device as claimed in claim 17, wherein the liquid crystal panel comprises:
two electrode substrates;
a liquid crystal layer, sandwiched between the electrode substrates;
two first alignment layers, respectively disposed between the liquid crystal layer and the electrode substrates;
at least one polarizing film, disposed on one electrode substrate opposite to the liquid crystal layer; and
a color filter, located between the first alignment layer on any side of the liquid crystal layer and an electrode substrate,
wherein the means is one of the polarizing film and the color filter.

19. The LCD device as claimed in claim 18, wherein the liquid crystal panel further comprises at least one phase retardation film, disposed on the polarizing film opposite to the liquid crystal layer.

20. The LCD device as claimed in claim 19, wherein the at least one phase retardation film is formed by the second alignment layer and the polarized light emitting liquid crystal film.

21. The LCD device as claimed in claim 17, wherein the lights emitted by the light emitting source comprise UV light; and the lights emitted by the polarized light emitting liquid crystal film comprise visible light.

22. The LCD device as claimed in claim 21, further comprising a reflective layer, located between the light emitting source and the polarized light emitting liquid crystal film, wherein the reflective layer enables the UV light to pass through and reflects the polarized visible light.
